(19) United States
(12) Patent Application Publication
(10) Pub. No.: US 2008/0245224 A1
(43) Pub. Date: Oct. 9, 2008

(54) ADJUSTING UNIT FOR AN AXIAL PISTON MACHINE

(76) Inventors: Martin Wustefeld, Neumunster (DE); Juraj Bohus, Dunica nad Vahom (SK)

Correspondence Address: ZARLEY LAW FIRM P.L.C., CAPITAL SQUARE, 400 LOCUST, SUITE 200, DES MOINES, IA, 50309-2350, US

(21) Appl. No.: 12/062,629

(22) Filed: Apr. 4, 2008

(30) Foreign Application Priority Data
Apr. 4, 2007 (DE) 102007016293

(51) Int. Cl. F15B 13/00

(52) U.S. Cl. 91/505

(57) ABSTRACT

The invention relates to an adjusting unit for an axial piston machine, having a valve unit for controlling the oil pressure which loads a servo system, the valve unit having a substantially cylindrical valve slide which can be displaced along its centre longitudinal axis in the valve unit. On both sides of a plane of symmetry which is perpendicular with respect to the centre longitudinal axis, the valve slide has flattened portions which extend on the cylindrical outer cover parallel to the centre longitudinal axis and are delimited by control edges, as a result of which the connections to the two servo sides are controlled in such a way that, in a centred neutral position of the valve slide, the servo system is put into neutral and, when the valve slide is displaced from its centred neutral position, a different hydraulic pressure acts on the two servo sides which displaces the servo piston or the servo pistons correspondingly. A groove which reinforces the self-centring action is sunk in the flattened portions of the valve slide in the region of the respective control edge which lies to the side of the plane of symmetry.

### BACKGROUND OF THE INVENTION

The invention relates to an adjusting unit for an axial piston machine according to the precharacterizing clause of Claim 1. Adjusting units of this type serve to adjust the volumetric flow in axial piston machines and comprise one or more servo pistons, the movement of which is transmitted, for example, to a swash plate in order to change the delivery volume of the axial piston machine. Here, the servo system is controlled via a valve unit, by way of which hydraulic pressure is guided alternately to the two sides of the servo system.

DE 10 2004 033 376 B3 has disclosed a corresponding adjusting unit which has a valve unit with a substantially circular-cylindrical valve slide which can be displaced along its centre longitudinal axis in the valve unit. On both sides of a plane of symmetry which is perpendicular with respect to the centre longitudinal axis, the valve slide has planar flattened portions on the cylindrical outer cover which extend parallel to the centre longitudinal axis. These flattened portions are delimited in each case by control edges, as a result of which the connections to the two servo sides are controlled in such a way that, in a centred neutral position of the valve slide, the servo system is put into neutral and, when the valve slide is displaced from its centred neutral position, a different hydraulic pressure acts on the two servo sides which displaces the servo piston or the servo pistons correspondingly.

The neutral position of conventional valve slides is very sensitive. If the nominal dimensions are maintained exactly at the control edges, flow forces should in themselves have a self-centring action, this actually being the case, however, only in a very limited range of approximately ±40 μm about the neutral position. Outside this range, the flow forces have an opening action, an effect which is reinforced still further by unavoidable production tolerances.

The invention is based on the object of providing a valve unit with an improved self-centring action.

### SUMMARY OF THE INVENTION

According to the invention, this aim is achieved in an adjusting unit according to the precharacterizing clause of claim 1 by the fact that a groove which reinforces the self-centring action is sunk in the flattened portions of the valve slide in the region of the respective control edge which lies to the side of the plane of symmetry. In this way, the opening forces on the slide can be minimized. Moreover, the reinforcement (servo vs. slide displacement) is reduced in the region of the neutral position, as a result of which the settability is improved considerably.

The groove is preferably substantially parallel to the plane of symmetry of the valve slide and is sunk as an extension of the control edge, with the result that a groove wall at the same time forms the control edge. Here, the groove is preferably of crescent-shaped configuration and is delimited on one side by a circular section of the circular-cylindrical valve-slide cross section. However, other groove shapes are also possible, for example V-shaped or peripheral in the shape of an annular ring. However, the volumetric-flow consumption also increases as the size of the groove increases, with the result that it is important to find an optimum adaptation here.

A particularly good compromise between the self-centring action and the volumetric-flow consumption results if the groove dimensions satisfy the following conditions:

2≦r₁≦3

0.2≦r₂1.5

1.3≦r₃23 15.0,

where r₁=NT/AT, r₂=(NT−AT)/NB and r₃=r₁/r₂, NT denoting the groove depth, NB denoting the groove width and AT denoting the flattened-portion depth.

Here, the adjusting unit can be configured in such a way that the lines to the servo sides are closed in the centred neutral position of the valve slide. However, it is particularly advantageous if each servo side is connected both to housing pressure and to supply pressure in the centred neutral position of the valve slide. This results in a particularly stable neutral position for the servo system because a pressure is set on both servo sides which lies above the housing pressure in a targeted manner and the servo cylinders are prestressed somewhat in the neutral position in comparison with the tank level.

### BRIEF DESCRIPTION OF THE DRAWINGS

Further features and advantages of the invention result from the following description of the figures, in which:

FIG. 1 shows one exemplary embodiment of the valve slide according to the invention in plan view;

FIG. 2 shows the exemplary embodiment of FIG. 1 in side view;

FIG. 3 shows an illustration the valve slide in the housing of the valve unit; and

FIG. 4 shows an illustration relating to the dimensions of the groove which is sunk in the flattened portions.

### DETAILED DESCRIPTION OF THE PREFERRED EMBODIMENTS

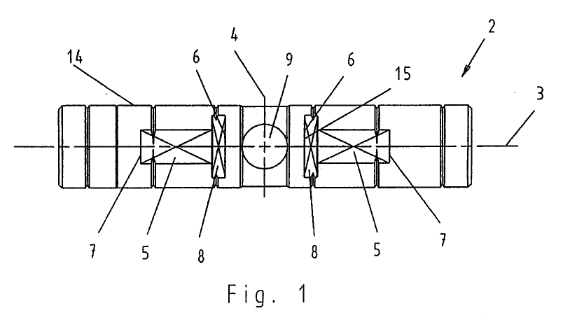

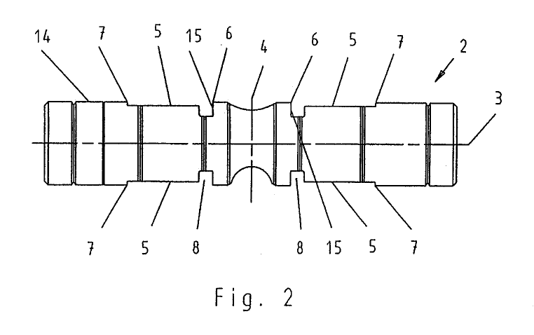

FIGS. 1 and 2 show the valve slide 2 of the adjusting unit according to the invention in plan and side view. The valve slide 2 is of substantially circular-cylindrical configuration and extends along its centre longitudinal axis 3. In the centre, the valve slide 2 has a transverse hole 9 which is perpendicular with respect to the centre longitudinal axis. A plane of symmetry 4 which is perpendicular with respect to the centre longitudinal axis extends through the said transverse hole 9. The valve slide 2 is of symmetrical construction with regard to the plane of symmetry 4. In each case planar flattened portions 5 which extend on both sides of the centre longitudinal axis 3 and parallel to the latter are sunk in the cylindrical outer cover 14 of the valve slide 2 on both sides of the plane of symmetry 4. The flattened portions 5 are delimited in each case by control edges 6, 7. In each case one groove 8 is sunk at the control edges 6, the tank control edges, which are adjacent to the plane of symmetry 4, which groove 8 terminates with the tank control edge in such a way that a groove wall 15 at the same time forms the control edge 6. The grooves 8 on both sides have a slightly higher volumetric-flow consumption as a result, but reinforce the self-centring action quite considerably which is responsible for a stable neutral position.

The action of the groove can be explained by the different forces which act on the slide. These are shear forces which in general have a self-centring action along the flattened portions, and dynamic pressure forces at the crescent-shaped faces of the control edges. In the prior art, the compressive force predominates at the crescent of the outer control edge 7, so that a tendency towards automatic opening of the slide results. A residual pressure difference therefore also as a rule remains on the servo system in the flowless state, which residual pressure difference can be compensated for by the installed spring energy but is undesirable overall. As a result of the formation of the groove in the region of the tank control edge 6, the dynamic pressure forces are increased there, which in total has a positive effect on the self-centring forces.

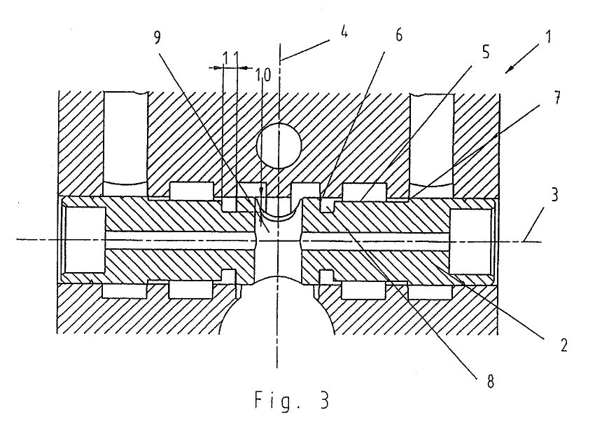

FIG. 3 shows the valve slide 2 in the housing of the valve unit 1. Here, the reference numerals have been retained for identical components. The control edges 6, 7 which are provided on the flattened portions 5 control the hydraulic pressure, with which a servo piston can be loaded via connecting lines. In the example which is shown, the valve slide 2 is displaced by an electromagnet (not shown). The above-described groove 8 which holds the valve slide 2 in a stable neutral position in a self-centring manner is sunk in the flattened portions at the tank control edges 6.

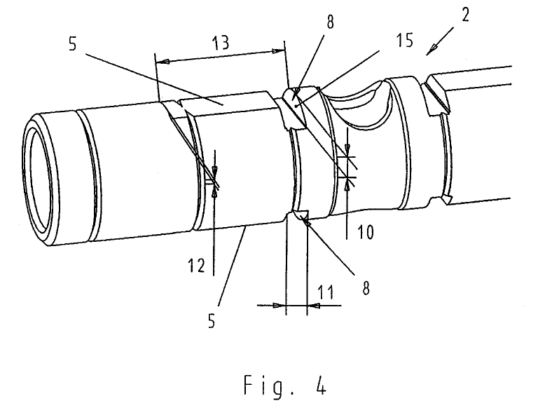

The dimensions of the valve slide 2 are described in detail using FIG. 4. A section of the valve slide 2 having the flattened portions S and the grooves 8 is shown. The invention is largely independent of the flattened-portion length 13 which is denoted by AL and can therefore be used in existing conventional systems without additional modifications.

The flattened-portion depth AT typically lies in the region of 0.5 mm. If the definitions r₁=NT/AT, r₂=(NT−AT)/NB and r₃=rt/r₂ are used, NT denoting the groove depth, AT denoting the flattened-portion depth and NB denoting the groove width, this results in an optimum compromise between a self-centring action and an increased volumetric-flow consumption, if the dimensions satisfy the following conditions (1)-(3):

2≦r₁23 3 (1)

0.2≦r₂≦1.5 (2)

1.3≦r₃≦15.0. (3)

The adjusting unit can be configured in a conventional way such that the lines to the servo sides are closed in the neutral position of the valve slide. However, the control edges of the valve slide are preferably configured in such a way that, in the neutral position, each servo side is connected both to housing pressure and to supply pressure in such a way that a pressure which lies above the housing pressure in a targeted manner is set in servo cylinders on both sides, and the servo cylinders are prestressed correspondingly in the neutral position in comparison with tank level.

The invention therefore provides an adjusting unit for axial piston machines, in which the active range of the self-centring action of the valve slide is doubled approximately and the hydraulic settability is improved considerably.

We claim:

1. Adjusting unit for an axial piston machine, having a valve unit for controlling the oil pressure which loads a servo system, the valve unit (1) having a substantially cylindrical valve slide (2) which can be displaced along its centre longitudinal axis (3) in the valve unit (1) and, on both sides of a plane of symmetry (4) which is perpendicular with respect to the centre longitudinal axis (3), has flattened portions (5) which extend on the cylindrical outer cover (14) parallel to the centre longitudinal axis (3) and are delimited by control edges (6, 7), as a result of which the connections to the two servo sides are controlled in such a way that, in a centred neutral position of the valve slide (1), the servo system is put into neutral and, when the valve slide (1) is displaced from its centred neutral position, a different hydraulic pressure acts on the two servo sides which displaces the servo piston or the servo pistons correspondingly, characterized in that a groove (8) which reinforces the self-centring action is sunk in the flattened portions (5) of the valve slide (2) in the region of the respective control edge (6) which lies to the side of the plane of symmetry (4)

2. Adjusting unit according to claim 1, in which the groove (8) extends substantially parallel to the plane of symmetry (4).

3. Adjusting unit according to claim 1 in which the groove (8) is sunk as an extension of the control edge (6), with the result that a groove wall (15) at the same time forms the control edge (6).

4. Adjusting unit according to claim 1 in which the groove (8) has a crescent-shaped edge and is delimited on one side by a circular section of the circular-cylindrical valve-slide cross section.

5. Adjusting unit according to claim 1 where 2≦r₁≦3, r₁=NT/AT and NT denoting the groove depth (10) and AT denoting the flattened-portion depth (12).

6. Adjusting unit according to claim 5 where 0.2≦r₂≦1.5, r₂=(NT−AT)/NB and NT denoting the groove depth (10), AT denoting the flattened-portion depth (12) and NB denoting the groove width (11).

7. Adjusting unit according to claim 6 where 1.3≦r₃≦15.0, r₃=r₁/r₂.

8. Adjusting unit according to claim 1 the lines to the servo sides being closed in the centred neutral position of the valve slide (2)

9. Adjusting unit according to claim 1 each servo side being connected both to housing pressure and to supply pressure in the centred neutral position of the valve slide (2), with the result that the servo cylinders are prestressed in the neutral position.
